(19) United States
(12) Patent Application Publication
(10) Pub. No.: US 2007/0078236 A1
(43) Pub. Date: Apr. 5, 2007

(54) Reactive thermosetting system with long storage life

(76) Inventors: Anthony Bonnet, Beaumont Le Roger (FR); Elisabeth Loerch, Brionne (FR); Laurent Gervat, Brassempouy (FR); Regis Cipriani, Tournedos Bois Hubert (FR); Francois Beaume, Bernay (FR)

Correspondence Address: ARKEMA INC.;PATENT DEPARTMENT - 26TH FLOOR, 2000 MARKET STREET, PHILADELPHIA, PA, 19103-3222, US

(21) Appl. No.: 10/585,700

(22) PCT Filed: Jan. 7, 2005
(86) PCT No.: PCT/FR05/00033

§ 371 Date: Jul. 11, 2006

(30) Foreign Application Priority Data
Jan. 13, 2004 (FR) 0400266

(51) Int. Cl. C08L 63/02

(52) U.S. Cl. 525/529; 525/107; 525/113; 525/114

(57) ABSTRACT

The present invention relates to a process which makes it possible to produce semifinished products, such as reactive textiles or films for composites, starting from two formulations, one based on epoxide resin and on a rheology-control agent and the other based on a hardener and on a rheology-control agent. These semifinished products are stable during storage but they can react together when the temperature is increased to form the desired thermoset material.

The present invention relates to the field of thermoset materials, particularly to a process for producing such materials. It discloses more particularly a process which makes it possible to produce semifinished products, such as reactive textiles or films for composites, starting from two formulations treated separately. These semifinished products are stable during storage but they can react together to form the thermoset material when the temperature is increased.

A thermoset material is defined as being formed of polymer chains of variable length bonded to one another via covalent bonds so as to form a three-dimensional network. Thermoset materials can be obtained, for example, by reaction of a thermosetting resin, such as an epoxy resin, with a hardener of amine type. Thermoset materials exhibit numerous advantageous properties which let them be used as structural adhesives or as matrix for composite materials or also in applications for the protection of electronic components.

The reinforcing fiber, which can comprise several thousand filaments, improves the mechanical characteristics of the composite structure. It can be composed of glass, of carbon, of aramid or of any other organic or inorganic material introducing the desired characteristics.

Epoxy materials have a high crosslinking density which provides them with a high glass transition temperature (Tg) and which confers excellent thermomechanical properties on the material. The higher the crosslinking density, the higher the Tg of the material and consequently the better the thermomechanical properties and the higher the operational temperature limit of the material.

Nevertheless, they remain difficult to handle. Solutions have been provided for facilitating the use thereof. For example, FR 2 841 252 provides a solution based on the use of a rheology-regulating agent based on a block copolymer, thus making it possible to obtain thermosetting films. Nevertheless, these materials require storage under cold conditions in order to prevent reaction from taking place during the storage stage.

The Applicant Company has just found that specific formulations based on thermosetting materials and on rheology-regulating agents can be converted into objects where the epoxy resin and its hardener are separated but sufficiently close to allow them to react subsequently when they are used while making possible beforehand easy handling and in particular high stability on storage.

The solution provided by the present invention is based on the simultaneous treatment of two formulations, one based on a thermosetting resin, for example composed of an epoxide prepolymer, and on a rheology-control agent, the other based on a hardener and on a rheology-control agent.

The simultaneous treatment makes it possible to obtain semifinished products, such as reactive textiles or films for composites. These semifinished products are stable during storage but they can react when the temperature is increased to form the desired thermoset material.

The first subject matter of the invention is a novel process for the preparation of thermoset materials and objects. This process can be described by the following stages:
a—Preparation of a formulation (A) based on epoxide prepolymers and on rheology-regulating agents,
b—Preparation of a formulation (B) based on hardeners and on rheology-regulating agents,
c—Preparation of semifinished products by simultaneous treatment of the formulations (A) and (B), if need be observing the stoichiometry between the epoxide prepolymer and the hardener and, if appropriate, including the fibers, mats, woven fabrics or any other material commonly used in composite materials,
d—Production of the desired structures with the semifinished product obtained in c according to standard techniques for the processing of semifinished products for thermoset composites, such as molding, including drape molding, or the production of sandwich systems,
e—Reaction of the formulation in order to obtain a composite material according to the standard techniques for the processing of thermoset composite materials by combination of the formulations (A) and (B) by contributing heat and optionally pressure, such as heat forming.

The formulation (A) of the invention comprises:
from 1 to 90% by weight of the total weight of the formulation of a rheology-control agent (I) comprising, for example, at least one block copolymer chosen from S—B-M, B-M and M-B-M block copolymers in which:
each block is connected to the other by means of a covalent bond or of one or more intermediate molecules connected to one of the blocks via a covalent bond and to the other block via another covalent bond,
M is a polymer miscible with the thermosetting resin, for example a methyl methacrylate homopolymer or a copolymer comprising at least 50% by weight of methyl methacrylate,
B is incompatible with the thermosetting resin and with the M block,
S is incompatible with the thermosetting resin and with the B block,
from 10 to 99% by weight of the total weight of the formulation of at least one thermosetting resin (II).

It can additionally comprise from 0 to 50% by weight of the total weight of the formulation of at least one thermoplastic material (III).

The formulation (B) comprises, by weight, from 1 to 90% of at least one hardener and from 10 to 99% of at least one rheology-regulating agent (I). A and B not necessarily comprising the same rheology-regulating agent. The formulations A and B of the invention exhibit a thermoplastic behavior and can be processed by the standard techniques for the conversion of thermoplastic materials but have the property of reacting together to form a thermoset material. These formulations can be found, during the reaction, in a perfectly liquid or rubbery state.

A person skilled in the art knows how to set the amounts of A and of B to be used according to the object to be prepared.

As regards the thermoset material, it is defined as being formed of polymer chains of variable length bonded to one another via covalent bonds so as to form a three-dimensional network.

Mention may be made, by way of examples, of crosslinked epoxy resins.

The thermoset material advantageously originates from the reaction of a thermosetting epoxy resin and of a hardener. It is also defined as any product of the reaction of an oligomer carrying oxirane functional groups and of a hardener. Due to the reactions occurring in the reaction of these epoxy resins, a crosslinked material is produced corresponding to a three-dimensional network which is more or less dense according to the base characteristics of the resins and hardeners employed.

The term “epoxy resin”, hereinafter denoted by E, is understood as meaning any organic compound having at least two functional groups of oxirane type which can polymerize by ring opening. The term “epoxy resins” denotes any conventional epoxy resin which is liquid at ambient temperature (23° C.) or at a higher temperature. These epoxy resins can be monomeric or polymeric on the one hand, aliphatic, cycloaliphatic, heterocyclic or aromatic on the other hand. Mention may be made, as examples of such epoxy resins, of resorcinol diglycidyl ether, bisphenol A diglycidyl ether, triglycidyl-p-aminophenol, bromobisphenol F diglycidyl ether, triglycidyl-m-aminophenol, tetraglycidyl-methylenedianiline, (trihydroxyphenyl)methane triglycidyl ether, phenol-formaldehyde novolac polyglycidyl ethers, ortho-cresol novolac polyglycidyl ethers and tetraphenylethane tetraglycidyl ethers. Mixtures of at least two of these resins can also be used.

Preference is given to epoxy resins having at least 1.5 oxirane functional groups per molecule and more particularly to epoxy resins comprising between 2 and 4 oxirane functional groups per molecule. Preference is also given to epoxy resins having at least one aromatic ring, such as bisphenol A diglycidyl ethers.

As regards the hardener, mention may be made of:
acid anhydrides, including succinic anhydride,
aromatic or aliphatic polyamines, including diaminodiphenyl sulfone (DDS) or else methylenedianiline or else 4,4′-methylenebis(3-chloro-2,6-diethylaniline) (MCDEA),
dicyandiamide and its derivatives,
imidazoles,
polycarboxylic acids,
polyphenols.

The term “rheology-control agent” is understood to mean a compound which, blended with a thermosetting material, makes it possible for the latter to be able to be converted by any technique for the processing of thermoplastics while retaining the property of reacting to form a thermoset material. The choice will advantageously be made of a block copolymer chosen from S—B-M, B-M or M-B-M block copolymers in which:
each block is connected to the other by means of a covalent bond or of one or more intermediate molecules connected to one of the blocks via a covalent bond and to the other block via another covalent bond,
M is a polymer miscible with the thermosetting resin. Preferably, M is composed of methyl methacrylate monomers or comprises at least 20% by weight of methyl methacrylate, preferably at least 50% by weight of methyl methacrylate. The other monomers constituting the M block may or may not be acrylic monomers and may or may not be reactive. The term “reactive monomer” is understood to mean a chemical group capable of reacting with the oxirane functional groups of the epoxy molecules or with the chemical groups of the hardener. Mention may be made, by way of nonlimiting examples of reactive functional groups, of oxirane functional groups, amine functional groups or carboxyl functional groups. The reactive monomer can be (meth)acrylic acid or any other hydrolyzable monomer resulting in these acids. Mention may be made, among the other monomers which can constitute the M block, by way of nonlimiting examples, of glycidyl methacrylate or tert-butyl methacrylate. Advantageously, M is composed of syndiotactic PMMA to at least 60%.
B is a polymer incompatible with the thermosetting resin and with the M block. Advantageously, the Tg of B is less than 0° C. and preferably less than −40° C. The monomer used to synthesize the elastomeric B block can be a diene chosen from butadiene, isoprene, 2,3-dimethyl-1,3-butadiene, 1,3-pentadiene or 2-phenyl-1,3-butadiene. B is advantageously chosen from poly(dienes), in particular poly(butadiene), poly(isoprene) and their random copolymers or also from partially or completely hydrogenated poly(dienes). Use is advantageously made, among polybutadienes, of those having the lowest Tg, for example 1,4-polybutadiene with a lower Tg (approximately −90° C.) than that of 1,2-polybutadiene (approximately 0° C.). The B blocks can also be hydrogenated. This hydrogenation is carried out according to the standard techniques. The monomer used to synthesize the elastomeric B block can also be an alkyl(meth)acrylate; the following Tg values, between brackets, following the name of the acrylate are obtained: ethyl acrylate (−24° C.), butyl acrylate (−45° C.), 2-ethylhexyl acrylate (−60° C.), n-octyl acrylate (−62° C.), hydroxyethyl acrylate (−15° C.) and 2-ethylhexyl methacrylate (−10° C.). Use is advantageously made of butyl acrylate. The acrylates are different from those of the M block in order to observe the condition of B and M being incompatible. Preferably, the B blocks are predominantly composed of 1,4-polybutadiene. B is incompatible with the thermosetting resin and with the M block and its glass transition temperature Tg is less than the operating temperature of the thermoset material,
S is incompatible With the thermosetting resin and with the B block. The Tg or the M.p. of S is advantageously greater than the Tg of B and than 23° C. and preferably greater than 50° C. Mention may be made, by way of examples of S blocks, of those which derive from vinylaromatic compounds, such as styrene, α-methylstyrene or vinyltoluene, and those which derive from alkyl esters of acrylic acid and/or methacrylic acid having from 1 to 18 carbon atoms in the alkyl chain.

The S—B-M, B-M or M-B-M copolymer has a weight-average molar mass which can be between 10 000 g/mol and 500 000 g/mol, preferably between 20 000 and 200 000 g/mol. Advantageously, expressed as fraction by weight, the total of which is 100%, its composition will be:

for M: between 10 and 80% and preferably between 15 and 70%.

for B: between 2 and 80% and preferably between 5 and 70%.

for S: between 10 and 88% and preferably between 15 and 85%.

The block copolymers used in the materials of the present invention can be manufactured by anionic polymerization, for example according to the processes disclosed in patent applications EP 524 054 and EP 749 987.

Advantageously, the proportion of rheological agent is from 10 to 60% for respectively 90 to 40% of thermoset resin.

According to a preferred form of the invention, the rheology-control agent comprises at least one S—B-M block copolymer and at least one S—B block copolymer. It advantageously comprises between 5 and 80% of S—B diblock for respectively from 95 to 20% of S—B-M triblock.

As regards the S—B diblock, the S and B blocks are incompatible and they are composed of the same monomers and optionally comonomers as the S blocks and the B blocks of the S—B-M triblock. The S and B blocks can be identical to or different from the other S and B block present in the other block copolymers of the impact modifier in the thermoset material.

The S—B diblock has a weight-average molar mass which can be between 10 000 g/mol and 500 000 g/mol, preferably between 20 000 and 200 000 g/mol. The S—B diblock is advantageously composed of a fraction by weight of B of between 5 and 95% and preferably between 5 and 60%.

Furthermore, the advantage of these compositions is that it is not necessary to purify the S—B-M on conclusion of its synthesis. This is because the S—B-M triblocks are generally prepared from the S—B diblocks and the reaction often results in a blend of S—B and S—B-M which is subsequently separated in order to have available S—B-M.

According to an advantageous form, a portion of the S—B-M can be replaced by an S—B diblock. This portion can be up to 70% by weight of the S—B-M.

It would not be departing from the scope of the invention to replace all or part of the S—B-M triblock by an M-S—B—S-M or M-B—S—B-M pentablock. They can be prepared by anionic polymerization like the di- or triblocks mentioned above but using a difunctional initiator. The number-average molar mass of these pentablocks is within the same ranges as that of the S—B-M triblocks. The proportion of the two M blocks together, of the two B or S blocks together is within the same ranges as the proportions of S, B and M in the S—B-M triblock.

The formulation of the invention can be prepared by blending the epoxide prepolymer and the rheology-regulating agent (formula A) and the hardener with the rheology-regulating agent (formula B) by any conventional blending technique. Use may be made of any thermoplastic technique which makes it possible to produce a homogeneous blend between the two parts of the thermosetting resin and the control agent, such as extrusion. The material thus obtained, unreacted or partially reacted, can thus be provided in the form of a handleable rubbery material. The two types of formulae, formula A and formula B, can be coextruded to form an unreacted thermoplastic film which is unreactive provided that the two parts of the film are not blended by a process of hot compression type.

It is obvious that this invention can be applied to a reactive liquid resin which can form, after reaction, a linear or branched polymer exhibiting a thermoplastic behavior.

The finished object of the invention can be used in various applications, as in the sports, industrial, automobile, electronics or aeronautics fields.

It would not be departing from the scope of the invention to add the standard additives to the formulation, such as thermoplastics, for example polyethersulfones, polysulfones, polyetherimides or poly(phenylene ether)s, liquid elastomers or impact modifiers of core-shell type.

Curing Conditions:

These are the standard conditions.

### EXAMPLES

The following products were used:

Epoxy resin: it is a bisphenol A diglycidyl ether (BADGE) with a molar mass of 383 g/mol and with a mean number of hydroxyl groups per one epoxy group of n=0.075, sold by Vantico under the commercial reference LY556.

Hardener: it is an amine hardener which is an aromatic diamine, 4,4′-methylenebis-(3-chloro-2,6-diethylaniline), sold by Lonza under the commercial reference Lonzacure M-DEA. This product is characterized by a melting point of between 87° C. and 90° C. and a molar mass of 310 g/mol.

SBM1: it is an S—B-M triblock copolymer in which S is polystyrene, B is polybutadiene and M is poly(methyl methacrylate). SBM1 comprises 12% as fraction by weight of polystyrene, 10% as fraction by weight of polybutadiene and 78% by weight of poly(methyl methacrylate), obtained by anionic polymerization successively of a polystyrene block with a weight-average molar mass of 6000 g/mol, of a polybutadiene block with a mass of 5000 g/mol and of a poly(methyl methacrylate) block with a weight-average molar mass of 40 000 g/mol. This product was prepared according to the procedure disclosed in EP 524 054 and in EP 749 987. This product exhibits three glass transitions, one at −90° C., another at 95° C. and the third at 130° C.

SBM2: it is an S—B-M triblock copolymer in which S is polystyrene, B is polybutadiene and M is poly(methyl methacrylate). SBM2 comprises 13% as fraction by weight of polystyrene, 11% as fraction by weight of polybutadiene and 74% by weight of poly(methyl methacrylate), obtained by anionic polymerization successively of a polystyrene block with a weight-average molar mass of 10 400 g/mol, of a polybutadiene block with a mass of 8800 g/mol and of a poly(methyl methacrylate) block with a weight-average molar mass of 59 200 g/mol. This product was prepared according to the procedure disclosed in EP 524 054 and in EP 749 987. This product exhibits three glass transitions, one at −90° C., another at 95° C. and the third at 130° C.

Curing Conditions:

The blends are cured at 220° C. for 2 hours.

Measurement of the Main Mechanical Relaxation Temperature Tα by Thermomechanical Analysis:

The measurement of Tα was carried out by dynamic mechanical analysis on postcured samples using a Rheometrics device (Rheometrics Solid Analyser RSAII). The samples, of parallelepipedal shape (1×2.5×34 mm³), are subjected to temperature sweeping between 50 and 250° C. in tensile mode at a frequency of 1 Hz. The glass transition temperature is taken at the maximum of tan δ.

### Example 1

### According to the Invention

An SBM1 with a total Mn of 51 000 g/mol is blended with a BADGE with a mass of 383 g/mol by extrusion at 190° C. in a Werner corotating twin-screw extruder to produce the formula A. The SBM content is 40%. The same SBM is blended with the MDEA using the same corotating twin-screw extruder to produce the formula B. The SBM content is 40%. The products are extruded starting from the formula A and the formula B. These two types of yarns are subsequently woven while observing a grammage which makes it possible to obtain the stoichiometry between the epoxide and the amine. The woven fabric is subsequently placed under a press at 200° C. for 2 h. A thermoset material is obtained exhibiting a Tg of 165° C.

### Example 2

### According to the Invention

An SBM2 with a total Mn of 80 000 g/mol is blended with a BADGE with a mass of 383 g/mol by extrusion at 190° C. in a Werner corotating twin-screw extruder to produce the formula A. The SBM2 content is 40%. The SBM1 with a total of 51 000 g/mol is blended with the MDEA using the same corotating twin-screw extruder to produce the formula B. The SBM1 content is 40%. The products are extruded starting from the formula A and the formula B. These two types of yarns are subsequently woven while observing a grammage which makes it possible to obtain the stoichiometry between the epoxide and the amine. The woven fabric is subsequently placed under a press at 200° C. for 2 h. A thermoset material is obtained exhibiting a Tg of 164° C.

### Example 3 (Comparative)

40 g of SBM1 and 60 g of a mixture of BADGE epoxide from Dow Chemicals with a molar mass of 348.5 g/mol and of amine MDEA from Lonza are introduced onto a roll mixer. The BADGE and the MDEA are introduced into the mixture stoichiometrically, i.e. 41.53 g of BADGE and 18.47 g of MDEA. The mixture is produced at 150° C. After compression, the film obtained is transparent and exhibits a thickness of 100 μm. The film can be handled at ambient temperature. After storing for 1 month at ambient temperature, the film became rigid and brittle and cannot be easily handled. Its glass transition temperature is 26° C.

### Example 4

### According to the Invention

An SBM1 with a total Mn of 51 000 g/mol is blended with a BADGE with a mass of 383 g/mol by extrusion at 190° C. in a Werner corotating twin-screw extruder to produce the formula A. The SBM content is 40%. The same SBM is blended with the MDEA using the same corotating twin-screw extruder to produce the formula B. The SBM content is 40%. Coextrusion of the formula A and the formula B is carried out on a coextrusion cast device from Collin. The width of the film is 200 mm and its total thickness is 100 μm. The layer A, based on the formula A, exhibits a thickness of 65 μm and the layer B, based on the formula B, exhibits a thickness of 35 μm. The film is coextruded with a polyethylene backing film to prevent the film from adhering to itself during winding off. The film, after storing for 1 month at ambient temperature, can still be handled; the level of reaction at the interface is sufficiently low for the film to retain its thermoplastic nature. The polyethylene film is removed without any difficulties from the coextruded A+B structure. This structure is placed in a mold and compressed under 50 kg/cm² at 220° C. for 4 h. The material obtained exhibits all the characteristics of a thermoset material, it cannot be dissolved in toluene and exhibits a glass transition temperature of 170° C.

### Example 5

### According to the Invention

An SBM2 with a total Mn of 80 000 g/mol is blended with a BADGE with a mass of 383 g/mol by extrusion at 190° C. in a Werner corotating twin-screw extruder to produce the formula A. The SBM2 content is 40%. The SBM1 with a total Mn of 51 000 g/mol is blended with the MDEA using the same corotating twin-screw extruder to produce the formula B. The SBM1 content is 40%. Coextrusion of the formula A and the formula B is carried out on a coextrusion cast device from Collin. The width of the film is 200 mm and its total thickness is 100 μm. The layer A, based on the formula A, exhibits a thickness of 65 μm and the layer B, based on the formula B, exhibits a thickness of 35 μm. The film is coextruded with a polyethylene backing film to prevent the film from adhering to itself during winding off. The film, after storing for 1 month at ambient temperature, can still be handled; the level of reaction at the interface is sufficiently low for the film to retain its thermoplastic nature. The polyethylene film is removed without any difficulties from the coextruded A+B structure. This structure is placed in a mold and compressed under 50 kg/cm² at 220° C. for 4 h. The material obtained exhibits all the characteristics of a thermoset material, it cannot be dissolved in toluene and exhibits a glass transition temperature of 170° C.

### Example 6 (Comparative)

40 g of SBM1 and 60 g of a mixture of BADGE epoxide from Dow Chemicals with a molar mass of 348.5 g/mol and of amine MDEA from Lonza are introduced onto a roll mixer. The BADGE and the MDEA are introduced into the mixture stoichiometrically, i.e. 41.53 g of BADGE and 18.47 g of MDEA. The mixture is produced at 150° C. After compression, the film obtained is transparent and exhibits a thickness of 100 μm. The film can be handled at ambient temperature. After storing for 1 month at ambient temperature, the film became rigid and brittle and cannot be easily handled. Its glass transition temperature is 26° C.

1. A process for the preparation of thermoset materials and objects comprising:
a—preparing a formulation (A) comprising, by weight, from 10 to 99% of at least one epoxide prepolymer and from 1 to 90% of at least one first rheology-regulating agent (1),
b—preparing a formulation (B) comprising, by weight, from 1 to 90% of at least one hardener and from 10 to 99% of at least one second rheology-regulating agent (II),
c—preparing a semifinished product by mixing formulation A and formulation B,
d—preparing a desired structure with the semifinished product obtained in c, and thereafter
e—reacting formulation A and formulation B in the desired structure to obtain a composite material.

2. The process as claimed in claim 1, characterized in that the first rheology-regulating agent and second rheology-regulating agent are individually at least one block copolymer chosen from S—B-M, B-M or M-B-M block copolymers in which:
each block is connected to the other by means of a covalent bond or of one or more intermediate molecules connected to one of the blocks via a covalent bond and to the other block via another covalent bond,
M is a polymer miscible with the epoxide prepolymer,
B is incompatible with the epoxide prepolymer and with the M block,
S is incompatible with the thermosetting resin and with the B block.

3. The process as claimed in claim 2, characterized in that the M block is chosen from poly(methyl methacrylate) homopolymers or copolymers comprising at least 20% by weight of methyl methacrylate.

4. The process as claimed in claim 3, characterized in that the M blocks of the block copolymers are composed of at least 75% syndiotactic PMMA.

5. The process as claimed in claim 2, characterized in that the M blocks of the block copolymers additionally comprise reactive monomers.

6. The process as claimed in claim 2, characterized in that the Tg of the B blocks is less than 0° C.

7. The process as claimed in claim 2, characterized in that the B block is chosen from poly(alkyl acrylate)s, or polydienes.

8. The process as claimed in claim 7, characterized in that the B block is a 1,4-polybutadiene.

9. The process as claimed in claim 7, characterized in that the dienes of the B block are hydrogenated.

10. The process as claimed in claim 2, characterized in that the Tg or the M.p. of S is greater than 23° C.

11. The process as claimed in claim 10, characterized in that S is polystyrene.

12. The process as claimed in claim 2, characterized in that the weight-average molar mass of the block copolymers is between 10 000 g/mol and 500 000 g/mol.

13. The process as claimed in claim 12, characterized in that the weight-average molar mass of the block copolymers is between 20 000 g/mol and 200 000 g/mol.

14. The process as claimed in claim 1, characterized in that said preparation of a semifinished product is via coweaving.

15. A woven or knitted fabric prepared according to the process of claim 14.

16. The process as claimed in claim 1, characterized in that said preparation of a semifinished product is via coextrusion.

17. The process as claimed in claim 1, characterized in that said preparation of a semifinished product is via impregnation by a mixture of powders.

18. A thermoset object prepared according to the process of claim 16.

19. The process of claim 1, characterized in that said semifinished product further comprises fibers, mats, woven fabric or combinations thereof.

20. The process of claim 1, characterized in that said reacting comprises heating, applying pressure or a combination thereof.

21. The process of claim 1, characterized in that said first rheology-regulating agent (I) and said at least one second rheology-regulating agent (II) are the same or different.

22. The process of claim 5, characterized in that said reactive monomer is selected from glycidyl methacrylate, tert-butyl methacrylate or acrylic acid.

23. The process of claim 6, characterized in that the Tg of the B blocks is less than −40° C.

24. The process of claim 7, characterized in that said poly(alkyl acrylate) is selected from poly(butyl acrylate), poly(ethylhexyl acrylate) or poly(octyl acrylate).

25. The process of claim 10, characterized in that the Tg of S is greater than 50° C.

26. A thermoset object prepared according to the process of claim 17.
